(19) United States
(12) Patent Application Publication
(10) Pub. No.: US 2011/0010318 A1
(43) Pub. Date: Jan. 13, 2011

(54) SYSTEM AND METHOD FOR EMPIRICAL ENSEMBLE- BASED VIRTUAL SENSING

(75) Inventor: Davide Roverso, Halden (NO)

Correspondence Address: BIRCH STEWART KOLASCH & BIRCH, PO BOX 747, FALLS CHURCH, VA, 22040-0747, US

(73) Assignee: Institutt For Energiteknikk, Kjeller (NO)

(21) Appl. No.: 12/733,173

(22) PCT Filed: Aug. 15, 2008
(86) PCT No.: PCT/NO2008/000293

§ 371 Date: Mar. 26, 2010

Related U.S. Application Data
(60) Provisional application No. 60/935,548, filed on Aug. 17, 2007.

(51) Int. Cl. G06F 15/18; G05B 13/02

(52) U.S. Cl. 706/12

(57) ABSTRACT

An empirical ensemble based virtual sensor system (VS) for the estimation of an amount of water (C) or oil (A) in a fluid mixture, said virtual sensor comprising two or more empirical models (NN₁, NN₂, . . . , NNₙ). The amount is estimated in each of the empirical models (NN₁, NN₂, . . . , NNₙ), and a combination function combines (f) the results from the empirical models (NN₁, NN₂, . . . , NNₙ) to provide a combined estimate for the amount (y_{R}) that is more accurate than the estimated amount (y₁, y₂, . . . , yₙ) from each of the individual empirical models (NN₁, NN₂, . . . , NNₙ). The total performance of the virtual sensor system may be increased by increasing the number of empirical models (NN₁, NN₂, . . . , NNₙ).

This application is the National Phase of PCT/NO2008/000293 filed on Aug. 15, 2008, which claims priority under 35 U.S.C. 119(e) to U.S. Provisional Application Nos. 60/935,548 filed on Aug. 17, 2001, all of which are hereby expressly incorporated by reference into the present application.

### TECHNICAL FIELD

The present invention relates to a method and system for empirical ensemble-based virtual sensing and more particularly to a method and system for virtual sensors for measuring parameters from the energy sector and process industry, such as an amount of oil in discharged water or a mass flow rate of a steam used to drive a turbine in a power plant.

### BACKGROUND

Discharges to sea and emissions to air from the oil and gas industry are of major concern to the quality of air and water. There has been several examples of unexpected and undesired discharges of oil in water from the oil industry, the discharges threatening the marine environment. In that respect the environmental authorities are imposing regulations to limit the discharge and emissions. As an example, the maximum permissible oil content in water discharged from installations on the Norwegian Shelf is 30 mg/l.

During oil production water is separated and discharged On the Norwegian shelf the amount of water discharged to the sea is in the order of hundred million m3 annually. Water is used for various processes, one is to inject the water back into the reservoir to increase the pressure and displace the oil in the reservoir to increase the recovery rate. During oil production the oil produced from the reservoir contains a large amount of water, and a separation process is necessary to separate oil from water. Due to the strict requirements as described above, the separation process is often performed in several steps. Faults related to any of the steps in the separation process, and especially the last step, may have serious consequences to the environment.

Traditionally, oil in water concentrations have been measured by daily laboratory analysis. Continuous tuning related to the separation process or other systems based on the measurement values may not be possible. When tuning is not optimized the discharges may become higher than expected over some time between the laboratory analysis. Thus, there is a need for a sensor allowing the real-time or near-real time monitoring of the oil in water concentration.

In many types of power plants, e.g. nuclear or coal based plants, water is heated in a boiler and the steam is sent through a turbine that runs a generator. The water and steam may run in a closed loop; an example is a nuclear boiling water reactor (BWR).

In a BWR the steam going to the turbine that powers the electrical generator is produced in the reactor core rather than in steam generators or heat exchangers used in other types of plants. The water is at lower pressure, about 75 times atmospheric pressure, compared to a pressurized water reactor with about twice that pressure, so in a BWR the water boils in the core at about 285° C.

Steam produced in the reactor core passes through steam separators and dryer plates above the core and then directly to the turbine.

Steam exiting from the turbine flows into condensers where the steam is cooled to water condensate; it is then pumped through feed-water heaters raising its temperature using extraction steam from the turbine. Feed-water from the feed-water heaters enters the reactor pressure vessel. The feed-water enters into the downcomer region and combines with water exiting the water separators. The feed-water subcools the saturated water from the steam separators. This water now flows down the downcomer region, which is separated from the core by a tall shroud. The water then goes through either jet pumps or internal recirculation pumps that provide additional pumping power. The water then goes the lower core plate into the nuclear core where the fuel elements heat the water. Water exiting the fuel channels at the top guide is by mass about 15% saturated steam.

In many power plants the steam flow is not measured and during start-up the turbine operator has to, in some BWRs, balance the feed-water flow with the unknown steam flow by indirectly observing the reactor tank level and manually controlling the feed-water flow.

There is thus a need for measuring the steam flow, but difficult to develop good sensors.

In general there is a range of situations where available instrumentation is not adequate for measurements, and the following list names the most common ones (As originally proposed by BioComp Systems, Inc. on their webpage http://www.biocompsystems.com/technology/virtualsensors/index.htm25.07.2008):
1. The physical quantity of interest is not measured on-line. A typical case is when samples are periodically sent to a laboratory for analysis. These could be air, water, oil, or material samples that are analysed to control environmental emission, discharge, product quality, or process condition.
2. The available physical sensor is too slow, in particular for use in automatic control.
3. The physical sensor is too far downstream, e.g the end product is continuously monitored to detect production deviations, but where this information comes too late to perform corrective action.
4. The physical sensor is too expensive.
5. There are no means of installing a physical sensor, e.g. no physical space.
6. The sensor environment is too hostile.
7. The physical sensor is inaccurate. Available physical sensors might be subject to either intrinsic inaccuracies or to degradation. Scaling in a Venturi flow-meter is a typical example.
8. The physical sensor is expensive to maintain.

Virtual sensing techniques, also known as soft or proxy sensing, are software-based techniques used to provide feasible and economical alternatives to costly or unpractical physical measurement devices and sensor systems. A virtual sensing system uses information available from other on-line measurements and process parameters to calculate an estimate of the quantity of interest.

A variety of virtual sensing techniques are available and can be classified in two major categories:
Analytical techniques
Empirical techniques

Analytical techniques base the calculation of the measurement estimate on approximations of the physical laws that govern the relationship of the quantity of interest with other available measurements and parameters.

A significant advantage of using analytical techniques based on “first principles” models is that it allows for the calculation of physically immeasurable quantities when these can be derived from the involved physical model equations.

The main weakness of the analytical approach is that it requires accurate quantitative mathematical models in order to be effective. For large-scale systems, such information may not be available or it may be too costly and time consuming to compile. Also, if changes are made to the plant, engineering work is needed to update and modify the physical models. Although modelling tools are available to support such model building and maintenance activities, process experts are needed for keeping plant models updated.

Empirical techniques base the calculations of the measurement estimate on available historical measurement data of the same quantity, and on its correlation with other available measurements and parameters. The historical data of the un-measured quantity can be derived either from actual measurement campaigns with temporarily installed sensor systems, from records of laboratory analyses, or from detailed estimations with complex analytical models that are computationally too expensive to run on-line. The latter is the only possible option if one wants to develop an empirical virtual sensor to estimate immeasurable quantities, for which there is obviously no historical data available.

Empirical virtual sensing is based on function approximation and regression techniques that can be implemented using a variety of statistical or machine learning modelling methods, such as:

Linear regression (see N. R. Draper and H. Smith, 1998. Applied Regression Analysis, Wiley Series in Probability and Statistics)

Weighted least squares regression (see Å. Björck, 1996. Numerical Methods for Least Squares Problems, Cambridge.)

Kernel regression (see J. S. Simonoff, 1996. Smoothing Methods in Statistics. Springer.)

Regression trees (see L. Breiman, J. Friedman, R. A. Olshen and C. J. Stone, 1984. Classification and regression trees. Wadsworth.)

Support Vector regression (see H. Drucker, C. J. C. Burges, L. Kaufman, A. Smola and V. Vapnik, 1997. Support Vector Regression Machines. Advances in Neural Information Processing Systems 9, NIPS 1996, 155-161, MIT Press.)

Neural Network regression (see J. Hertz, A. Krogh, and R. Palmer, 1991. Introduction to the Theory of Neural Computation. Addison-Wesley: Redwood City, Calif.)

Empirical modelling, also known as data-driven modelling, covers a set of techniques used to analyze the condition and predict the evolution of a process from operational data. It has the advantage of neither requiring a detailed physical understanding of the process nor knowledge of the material properties, geometry and other characteristics of the plant and its components, both of which are often lacking in real, practical cases.

The underlying process model is identified by fitting the measured or simulated plant data to a generic linear or non-linear model through a procedure which is often referred to as ‘learning’. This learning process may be active or passive, and involves the identification and embedding of the relationships between the process variables into the model. An active learning process involves an iterative process of minimizing an error function through gradient-based parameter adjustments. A passive learning process does not require mathematical iterations and consists only of compiling representative data vectors into a training matrix.

An important consideration in designing empirical models is that the training data must provide examples of the conditions for which accurate predictions will be queried. That is not to say that all possible conditions must exist in the training data, but that the training data should provide adequate coverage of these conditions. Empirical models will provide interpolative predictions, but the training data must provide adequate coverage above and below the interpolation site for this prediction to be sufficiently accurate. Accurate extrapolation, i.e. providing estimations for data that resides outside of the training data, is either not possible or not reliable for most empirical models.

Empirical models are reliably accurate only when applied to the same, or similar, operating conditions under which the data used to develop the model were collected. When plant conditions or operations change significantly, the model is forced to extrapolate outside the learned space, and the results will be of low reliability. This observation is particularly true for non-linear empirical models since, unlike linear models which extrapolate in a known linear fashion, non-linear models extrapolate in an unknown manner. Artificial neural network and local polynomial regression models are both non-linear; whereas transformation-based techniques such as Principal Components Analysis and Partial Least Squares, are linear techniques. Extrapolation, even if using a linear model, is not recommended for empirical models since the existence of pure linear relationships between measured process variables is not expected. Furthermore, the linear approximations to the process are less valid during extrapolation because the density of training data in these extreme regions is either very low or non-existent.

Artificial neural network models (see J. Hertz, A. Krogh, and R. Palmer, 1991. Introduction to the Theory of Neural Computation. Addison-Wesley: Redwood City, Calif.) contain layers of simple computing nodes that operate as non-linear summing devices. These nodes are highly interconnected with weighted connection lines, and these weights are adjusted when training data are presented to the neural network during the training process. Successfully trained neural networks can perform a variety of tasks, the most common of which are: prediction of an output value, classification, function approximation, and pattern recognition.

Only layers of a neural network that have an associated set of connection weights will be recognized as legitimate processing layers. The input layer of a neural network is not a true processing layer because it does not have an associated set of weights. The output layer on the other hand does have a set of associated weights. Thus, the most efficient terminology for describing the number of layers in a neural network is through the use of the term hidden layer. A hidden layer is a legitimate layer exclusive of the output layer.

A neural network structure consists of a number of hidden layers and an output layer. The computational capabilities of neural networks were proven by the general function approximation theorem which states that a neural network, with a single non-linear hidden layer, can approximate any arbitrary non-linear function given a sufficient number of hidden nodes.

The neural network training process begins with the initialization of its weights to small random numbers. The network is then presented with the training data which consists of a set of input vectors and corresponding desired outputs, often referred to as targets. The neural network training process is an iterative adjustment of the internal weights to bring the network's outputs closer to the desired values, given a specified set of input vector/target pairs. Weights are adjusted to increase the likelihood that the network will compute the desired output. The training process attempts to minimize the mean squared error (MSE) between the network's output values and the desired output values. While minimization of the MSE function is by far the most common approach, other error functions are available.

Neural networks are powerful tools that can be applied to pattern recognition problems for monitoring process data from industrial equipment. They are well suited for monitoring non-linear systems and for recognizing fault patterns in complex data sets. Due to the iterative training process the computational effort required to develop neural network models is greater than for other types of empirical models. Accordingly, the computational requirements lead to an upper limit on model size which is typically more limiting than that for other empirical model types.

Ensemble modelling (see T. G. Dietterich (Ed.), 2000. Ensemble Methods in Machine Learning, Lecture Notes in Computer Science; Vol. 1857. Springer-Verlag, London, UK)also known as committee modelling, is a technique by which, instead of building a single predictive model, a set of component models is developed and their independent predictions combined to produce a single aggregated prediction. The resulting compound model (referred to as an ensemble) is generally more accurate than a single component models, tends to be more robust to overfitting phenomena, has a much reduced variance, and avoids the instability problems sometimes associated with sub-optimal model training procedures.

In an ensemble, each model is generally trained separately, and the predicted output of each component model is then combined to produce the output of the ensemble. However, combining the output of several models is useful only if there is some form of “disagreement” between their predictions (see M. P. Perrone and L. N. Cooper, 1992. When networks disagree: ensemble methods for hybrid neural networks, National Science Fundation, USA) Obviously, the combination of identical models would produce no performance gain. One method commonly adopted is the so-called bagging method (see L. Breiman, 1996. Bagging Predictors, Machine Learning, 24(2), pp. 123-140), which tries to generate disagreement among the models by altering the training set each model sees during training. Bagging is an ensemble method that creates individuals for its ensemble by training each model on a random sampling of the training set, and, in forming the final prediction, gives equal weight to each of the component models. Other more elaborate schemes for ensemble generation and component model aggregation exist, and new ones can be devised.

The use of ensembles to reduce the overall model variance has a close relationship with regularization methods (see A. V. Gribok, J. W. Hines, A. Urmanov, and R. E. Uhrig. 2002. Heuristic, Systematic, and Informational Regularization for Process Monitoring. International Journal of Intelligent Systems, 17(8), pp 723-750, Wiley), which constrain the training of neural network models and their architecture to avoid ill-conditioned problems and achieve a similar control over excessive model variance.

U.S. Pat. No. 5,386,373 “Virtual continuous emission monitoring system with sensor validation” teaches the use of a virtual sensor for emissions, based on a neural network, to control the operations of a plant.

U.S. Pat. No. 6,882,929 “NOx emission-control system using a virtual sensor” teaches the use of a virtual sensor for emissions, based on a neural network, to control the operations of an engine.

US2005/0246297 Chen Dingding et al, “Genetic algorithm based selection of neural network ensemble for processing well logging data” teaches a method for generating a neural network ensemble for processing geophysical data, using an algorithm with multi-objective fitness function to select an ensemble with a desirable fitness function value.

Fortuna et al, “Virtual Instruments Based on Stacked Neural Networks to Improve Product Quality Monitoring in a Refinery” IEEE transactions and measurement, vol. 56 NO1, pages 95-101, February 2007, describes a virtual instrument for estimation of the octane number of gasoline in a refinery.

Torres-Sospedra et al, “Combining MF Networks: A Comparison Among Statistical Methods and Stacked Generalization” describes different methods for combining values from neural networks. Artificial Neural Networks in Pattern Recognition Lecture Notes in Computer Science;Lecture Notes in Artificial Intelligence; LNCS, 20060101 Springer, Berlin, DE, Vol: 4087, Page(s): 210-220, describes generic methods for stacking neural networks.

Virtual sensing is an attractive solution for measuring oil in water and mass flow rate, but there is a need for a system for continuous virtual sensing that is simpler to implement, more accurate, more robust and more stable than the above referenced systems.

### SHORT SUMMARY OF THE INVENTION

The present invention solves the problems of accuracy, robustness, stability and simplicity of a virtual sensor system by a combination of empirical modelling with ensemble modelling.

In an embodiment the present invention is an ensemble based virtual sensor system comprising;
two or more empirical models where each of the empirical models are arranged for being trained using empirical data, and further arranged for receiving one or more signal input values from one or more sensors, and for calculating a signal output value based on the signal input values,
a combination function arranged for receiving the signal output values and continuously calculating a virtual sensor output value as a function of the signal output values.

In an embodiment the present invention is a method for the estimation of a virtual sensor output value from one or more signal input values from one or more sensors comprising the following steps;
training an ensemble of empirical models with empirical data,
feeding the trained empirical models with the one or more signal input values from one or more sensors,
performing calculations of signal output values in the empirical models based on the signal input values,
continuously combining the signal output values and calculating a virtual sensor output value as a function of the signal output values.

In an embodiment of the invention the combination function (f) is arranged for continuously calculating the virtual sensor output value (y_{R}) as an average value of the signal output values (y₁, y₂, . . . , yₙ). The average value can be calculated as a geometrical or arithmetical mean value of the signal output values (y₁, y₂, . . . , yₙ) or a median value.

It is shown that the average calculation, in addition to be easy to implement also makes it possible to achieve a required accuracy that may not be possible with single-node virtual sensors.

In an embodiment of the present invention all the empirical models or inner nodes may have identical structure. This setup has the advantage that the required number of inner nodes can simply be instantiated in the virtual sensor system based on a template node. Further, the nodes may all be arranged for receiving the same set of signal input values from the sensors. Signals from the sensors are distributed to all the nodes, and the extra work of handling special cases is avoided.

In an embodiment the accuracy of the virtual sensor system according to the invention may be increased by instantiating a larger number of empirical models. Thus, it is not necessary to increase the complexity of the system to increase the accuracy. This way of achieving a better result simply by increasing the size of the ensemble is different from other methods that e.g. emphasise the selection of the ensemble.

As has been pointed out in the previous section, a virtual sensor system according to the present invention may solve many of the problems related to real-time or near real-time measurements of critical parameters within e.g. the energy sector and process industry. Specifically, in an embodiment of the present invention the virtual sensor system is arranged for the estimation of an amount of oil in discharged water. In another embodiment of the invention the virtual sensor system is arranged for the estimation of a mass flow rate of a steam used to drive a turbine in a power plant.

### BRIEF DESCRIPTION OF THE DRAWINGS

FIG. 1 shows a block diagram of an embodiment of a virtual sensor system according to the invention.

FIG. 2 shows in a graph the comparison between 50 individual estimates (thin lines), the actual value (dashed bold), and the ensemble output (bold cont.).

FIG. 3 shows the performance in ppm of a virtual sensor system according to the invention with increasing ensemble size to the right.

FIG. 4 shows a result of measured oil in water according to the invention.

FIG. 5 shows an example of the comparison between 728 individual outputs (thin black), actual value (black), and ensemble output (bold gray).

FIG. 6 shows an example of the Mean Absolute Error (MAE) for the ensemble in an embodiment of a virtual sensor system according to the invention.

FIG. 7 shows an example of how virtual sensor systems can be concatenated according to an embodiment of the invention.

FIG. 8 shows in a block diagram an embodiment of the invention for virtual multi-phase flow metering for use in oil and gas production.

FIG. 9 shows in a block diagram an embodiment of the invention for estimating an amount of gas from a combustion process.

### DESCRIPTION OF THE EMBODIMENTS OF THE INVENTION

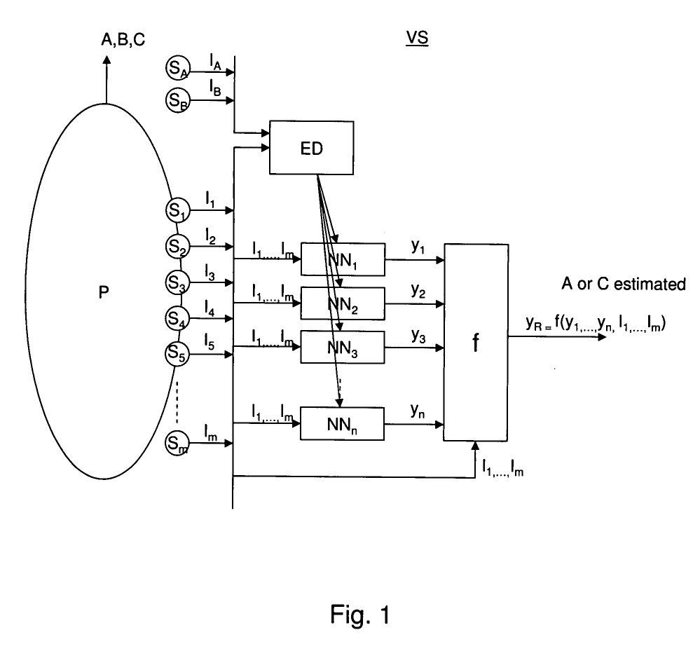

FIG. 1 is a block diagram of an embodiment of a virtual sensor system used to measure the amount (A,B,C) resulting from a process (P) according to the present invention.

In an embodiment the present invention the ensemble based virtual sensor system (VS) comprises two or more empirical models (NN₁, NN₂, . . . , NNₙ) where each of the empirical models (NN₁, NN₂, . . . , NNₙ) are arranged for estimating an intermediate result, and a combination function (f) is arranged for combining the intermediate results from the empirical models (NN₁, NN₂, . . . , NNₙ) to provide an estimation of the value that is more accurate than the signal output value (y₁, y2, . . . , yₙ) from each of the individual empirical models (NN₁, NN₂ , . . . , NNₙ).

More specifically, in this embodiment of the invention each of the empirical models (NN₁, NN₂, . . . , NNₙ) are arranged for being trained using empirical data (ED). In an embodiment of the invention the empirical data are historical measurement data from a process where the virtual sensor system (VS) is arranged. The empirical data (ED) of the un-measured quantity can be derived either from actual measurement campaigns with temporarily installed sensor systems (S_{A} and S_{B}) with sensor values (I_{A} and I_{B}) as well as in combination with fixed sensors (S₁, S₂, . . . , Sₘ) as shown in FIG. 1, from records of laboratory analyses, or from detailed estimations with complex analytical models that are computationally too expensive to run on-line. However training data can also be from other similar processes as can be understood by a person skilled in the art. The training data may be the same for all empirical models (NN₁, NN₂, . . . , NNₙ), or different, where e.g. not all process measurements are included for the training data of each of the empirical models (NN₁, NN₂, . . . , NNₙ). This is one way of providing diversity amongst the empirical models (NN₁, NN₂, . . . , NNₙ). They may also be initialized differently by setting different initialization parameters as can be understood by a person skilled in the art.

Each empirical model is further arranged for receiving one or more signal input values (I₁, I₂, . . . , Iₘ) from one or more sensors (S₁, S₂, . . . , Sₘ), and for calculating a signal output value (y₁, y2, . . . , yₙ) based on the signal input values (I₁, I₂, . . . , Iₘ). In addition the virtual sensor system (VS) comprises a combination function (f) arranged for receiving the signal output values (y₁, y₂, . . . , yₙ) from each of the empirical models and continuously calculating a virtual sensor output value (y_{R}) as a function of the signal output values (y₁, y₂, . . . , yₙ).

In an embodiment the invention is a method for the estimation of a virtual sensor output value (y_{R}) from one or more signal input values (I₁, I₂, . . . , Iₘ) from one or more sensors (S₁, S₂, . . . , Sₘ). The method comprises the following steps;
training an ensemble of empirical models (NN₁, NN₂, . . . , NNₙ) with empirical data,
feeding the trained empirical models (NN₁, NN₂, . . . , NNₙ) with one or more signal input values (I₁, I₂, . . . , Iₘ) from one or more sensors (S₁, S₂, . . . , Sₘ),
performing calculations of signal output values (y₁, y₂, . . . , yₙ) in the empirical models (NN₁, NN₂, . . . , NNₙ) based on the signal input values (I₁, I₂, . . . , Iₘ),
continuously combining the signal output values (y₁, y₂, . . . , yₙ) and calculating a virtual sensor output value (y_{R}) as a function of the signal output values (y₁, y₂, . . . , yₙ)

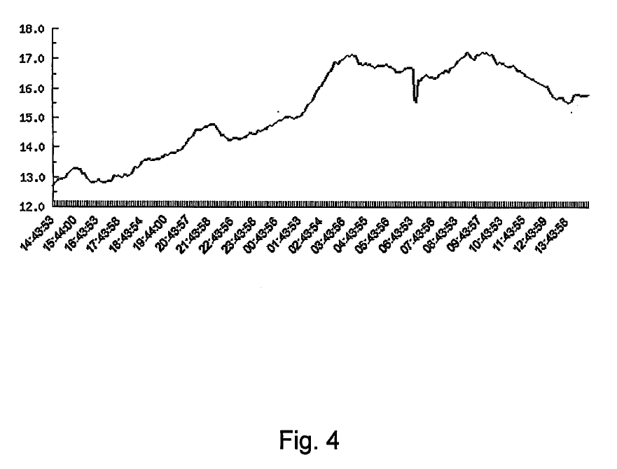

In an embodiment of the invention the virtual sensor system (VS) is arranged for the estimation of an amount of oil (A) in discharged water as shown in FIG. 1, wherein the virtual sensor output value (y_{R}) represents the amount of oil (A) in water. In another embodiment of the invention the virtual sensor system (VS) is arranged for the estimation of an amount of water (C) in discharged water, wherein the virtual sensor output value (y_{R}) represents the amount of water (C) in oil. In yet another embodiment of the invention the virtual sensor system (VS) is arranged for the estimation of a mass flow rate (B) of a steam used to drive a turbine in a power plant, wherein the virtual sensor output value (y_{R}) represents the mass flow rate (B). FIG. 4 shows an example of a result achieved by measuring oil in water concentration with a virtual sensor system (VS) according to the invention.

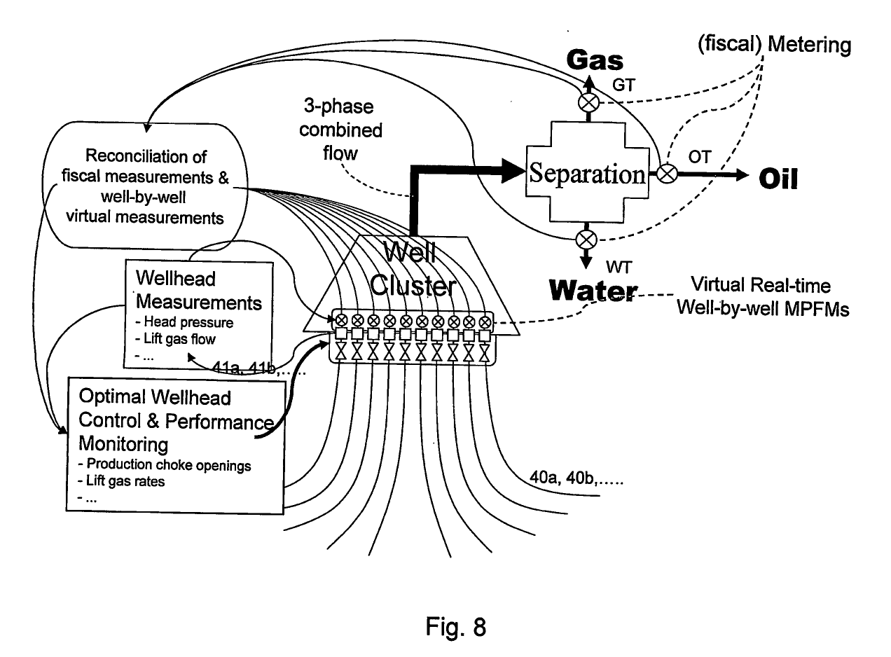

In an embodiment of the invention the virtual sensor system is arranged for multi-phase, real-time, well-by-well flow monitoring of oil platform or vessel wells as can be seen in FIG. 8. In this embodiment the virtual sensor system (VS) is arranged for the estimation of a gas flow rate (GRa, GRb, . . . ), a liquid flow rate (LRa, LRb, . . . ), and a water cut (WCa, WCb, . . . ) in a fluid mixture of one or more petroleum drilling wells (40a, 40b, . . . ) based on available wellhead measurements (41a, 41b, . . . ) in each of the wells (40a, 40b, . . . ) and actual measured total production from all the wells (40a, 40b, . . . ) of gas (GT), water (WT) and oil (OT) after a separation process (S).

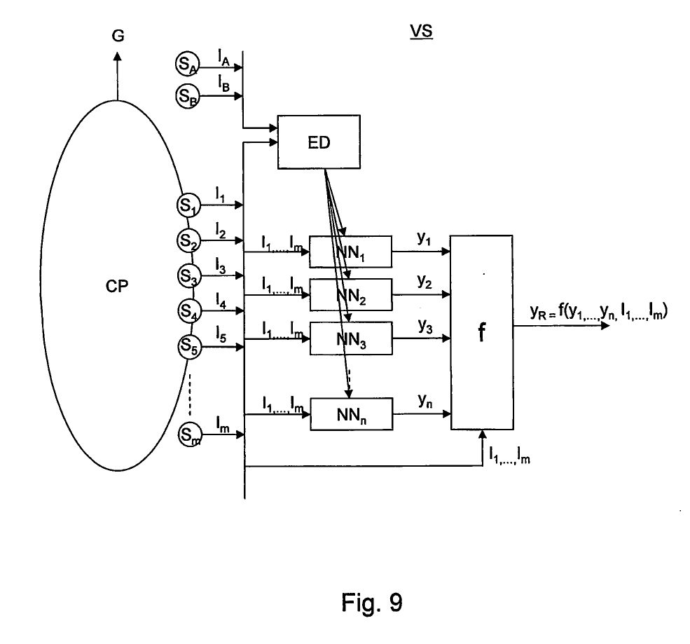

In another embodiment of the invention the virtual sensor system (VS) is arranged for the estimation of an amount of a gas (G) resulting from a combustion process (CP) as can be seen from FIG. 9. Examples of gases that may be estimated are NOx, CO2, etc.

In an embodiment of the present invention all the empirical models (NN₁, NN₂, . . . , NNₙ) or inner nodes may have identical structure. This setup has the advantage that the required number of inner nodes can simply be instantiated in the virtual sensor system based on a template node. In this embodiment also the format of corresponding inputs and outputs of the empirical models may be identical, i.e. the format of input 1 on empirical model NN₁ is the same as the format of input 1 on empirical model NN₂ to NNₙ etc.

The nodes may all be arranged for receiving the same set of signal input values (I₁, I₂, . . . , Iₘ) from the sensors (S₁, S₂, . . . , Sₘ). Signals from the sensors are distributed to all the nodes, and the extra work of handling special cases is avoided.

Empirical modelling has been described previously in this document and can be implemented using different techniques. In an embodiment of the invention the empirical models are neural networks.

The combination function (f) of the virtual sensor system may be arranged to calculate the output value (y_{R}) based on different criteria's. In an embodiment of the present invention the combination function (f) is arranged for continuously calculating the virtual sensor output value (y_{R}) as an average value of the signal output values (y₁, y₂, . . . , yₙ). The average value can be calculated as a geometrical or arithmetical mean value of the signal output values (y₁, y₂, . . . , yₙ), a median value or a combination of mean and median, such as the average of the two middle values. It can be shown that the performance of a virtual sensor system according to the invention with median value calculation in most cases is better than the mean value calculation due to the fact that the output is generally not affected by individual noise or irregularities when the median value calculation is used.

This approach counteracts the intrinsic variance that one can expect in the performance of empirical regression models such as neural networks. The origin of this variance can stem from various degrees of overfitting of the training data (i.e. resulting in modelling the noise in the data), from the typically random initialization of the neural network parameters before training, and from the non-deterministic gradient descent techniques used for fitting the neural network model to the data.

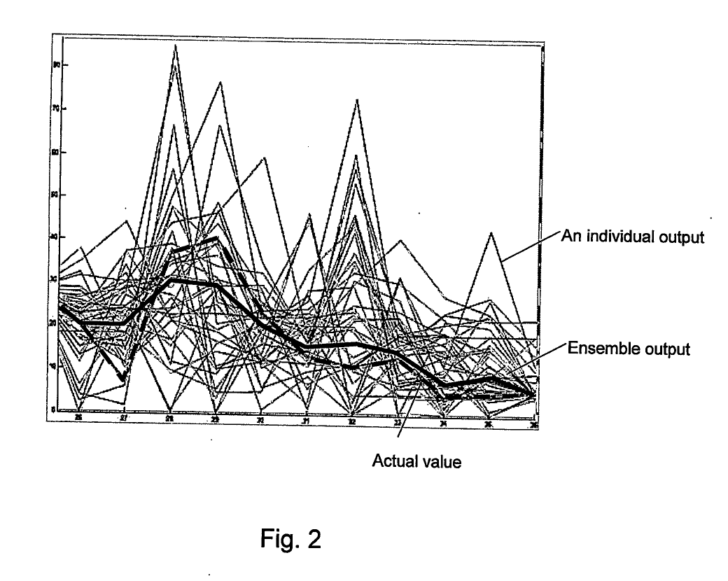

FIG. 2 illustrates the kind of variance that can result from a combination of these factors, a set of neural network virtual sensor models were developed to estimate residual oil concentrations in water discharged from an offshore oil platform. The figure shows the individual outputs of 50 models, the actual expected value being estimated, and the ensemble combination of the 50 individual estimates.

In an embodiment of the present invention the combination function (f) is arranged for receiving one or more of said signal input values (I₁, I₂, . . . , Iₘ) directly from the process sensors (S₁, S₂, . . . , Sₘ) in addition to the signal output values (y₁, y₂, . . . , yₙ) from the empirical models (NN₁, NN₂, . . . , NNₙ) and calculating a virtual sensor output value (y_{R}). In this embodiment of the invention the signal output values (y₁, y₂, . . . , yₙ) are individually, dynamically weighted based on the one or more signal input values (I₁, I₂, . . . , Iₘ). Dynamic weighting may reduce the impact on the virtual sensor output value from noise and disturbances related to one or more of the sensors or transmission lines from the sensors. In a related embodiment of the invention the combination function (f) is an empirical model (NN_{R}) arranged for receiving the signal input values (I₁, I₂, . . . , Iₘ) and calculating a virtual sensor output value (y_{R}) based on the signal output values (y₁, y₂, . . . , yₙ), the signal input values (I₁, I₂, . . . , Iₘ) and the structure of the empirical model (NN_{R}).

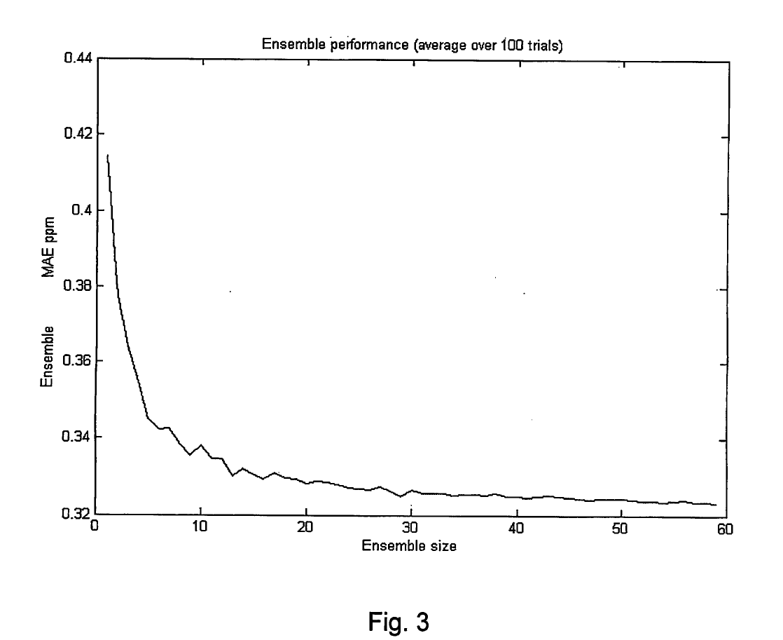

FIG. 3 shows how the performance or accuracy of an embodiment of a virtual sensor system (VS) according to the invention increases with the number of nodes. The performance requirement for a virtual sensor system in a given application may vary, and an unnecessary large number of nodes may slow down the initialization process of the virtual sensor system (VS). In an embodiment of the present invention the virtual sensor system (VS) is arranged for being able to instantiate a number of said empirical models (NN₁, NN₂, . . . , NNₙ) to accommodate specific performance criteria's. In an embodiment of the invention the virtual sensor system (VS) is arranged for dynamically allocating the required number of said empirical models (NN₁, NN₂, . . . , NNₙ) to achieve the predefined performance requirement of the virtual sensor output value (y_{R}). Performance requirements may be given in e.g. ppm (parts per million).

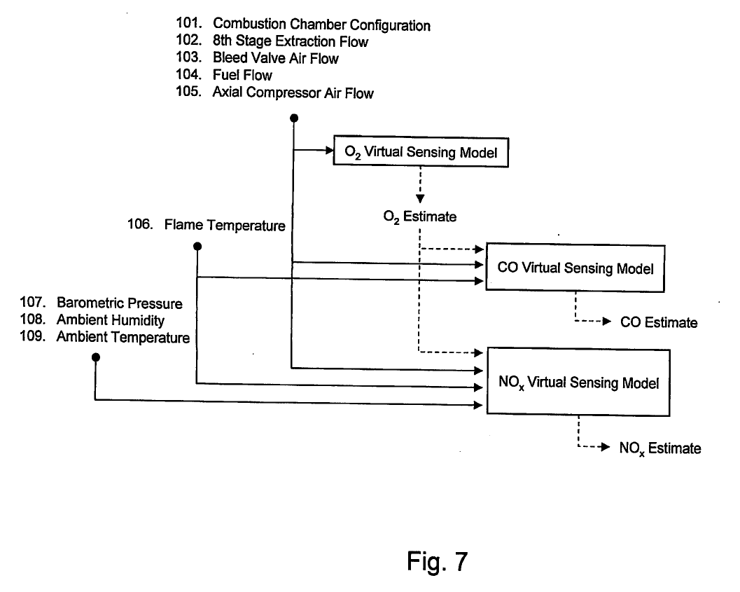

In an embodiment of the invention virtual sensor systems (VS) may be concatenated as can be seen from FIG. 7. Here it is shown in an example how O₂ from a combustion process is estimated in an embodiment of a virtual sensor system according to the invention. The O₂ concentration is estimated based on Combustion Chamber Configuration, 8th Stage Extraction Flow, Bleed Valve Air Flow, Fuel Flow and Axial Compressor Air Flow. The estimated O₂ concentration is used as an input to the NOx Virtual sensor together with these additional process measurement values; Flame Temperature, Barometric Pressure, Ambient Humidity and Ambient Temperature. Concatenation of virtual sensor systems may improve the performance of the system as well as simplify the structure of the empirical models, and the training of the system.

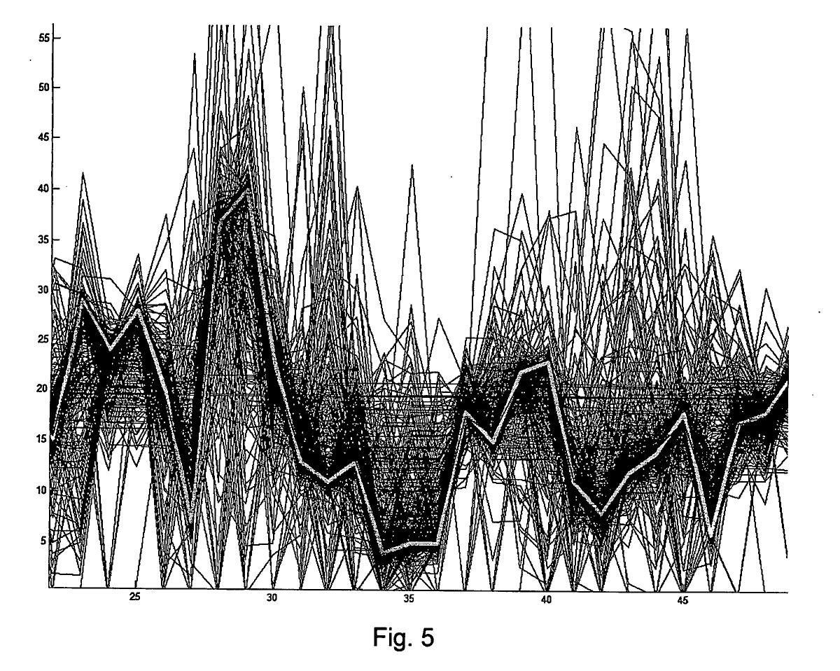

Tests of the present invention using different ensemble sizes have shown that ensemble performance improves with increasing ensemble size. This way of achieving a better result simply by increasing the size of the ensemble is different from other methods that e.g. emphasise the selection of the ensemble. In these tests ensemble size was varied from a minimum of 2 component models to a maximum of 59 component models. For each ensemble size, 100 individual trials were conducted and the resulting performance (expressed as Mean Absolute Error) was calculated. The collected results are summarised in FIG. 3, showing that values are tapering out at ensemble sizes of about 20-30 individuals. FIG. 5 shows an extreme case with more than 700 outputs.

In an embodiment of the present invention an oil/water separator, operating on an offshore oil platform in the Norwegian continental shelf, was mapped to identify optimal parameter settings to minimise discharges. To perform a mapping, lab analysis of daily samples were used and optimal parameter settings were identified.

In this embodiment 28 input parameters were used, among them; Centrifuge reject rate, Inlet Flow, Centrifuge inlet feed rate, Flashtank water outlet rate (today), Flashtank water Outlet flow, Flashtank water outlet rate prey day, Oil reject collection in tank level

Given these inputs a oil in water discharge virtual sensor system was developed using the present invention, where a number of models were individually constructed and then combined in an aggregated ensemble model.

In order to train and test these models, the original dataset of process and discharge data was split into a training set, a validation set, and a test set, where the training set was used to build the models, the validation set to control the modelling (i.e. to avoid overfitting the models to the training data), and the test set to evaluate model performance. The training data was 6 months of process data and laboratory analyses. The results shows that the virtual sensor system is more accurate than existing instruments. Similar results may be obtained with a steam flow virtual sensor system were input parameters are different pressure and temperature sensors in e.g. a nuclear power plant.

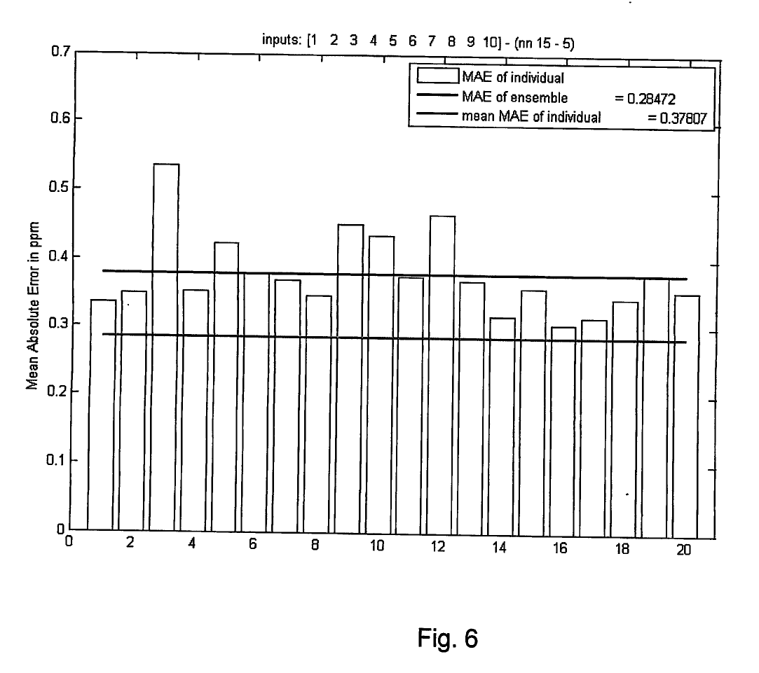

As an example from another application area where a virtual sensor system according to an embodiment of the present invention is used to measure Nitrogen Oxides (NOx) in exhaust gases from a combustion process, the results of the performance on the test dataset (i.e. data not used during training to build the model) are shown graphically in FIG. 6, and give a Mean Absolute Error of of 0.28472 ppm, where:

$$MAE = \frac{{\sum }_{i = 1}^{N} \vert {y}_{i} - {\hat{y}}_{i} \vert}{N}$$

and yᵢ is the expected value and ŷᵢ is the model estimate.

In another embodiment a plurality of models are generated and a mechanism is used for selecting particular models to be part of the ensemble. This is done either statically i.e. only once after the training phase, discarding unwanted models at the outset, or dynamically, i.e. introducing a weighing scheme that, given the current operational state, favours component models that have a demonstrated a better performance in or near that operational state.

In yet another embodiment hybrid ensemble models are used, i.e. ensembles where the component models are not necessarily of the same type but consist for example of neural networks as well as other regression models or a combination of empirical and analytical models.

1.-28. (canceled)

29. An ensemble based virtual sensor system (VS) for use in a petroleum production process (P) for the estimation of an amount of water (C) or oil (A) in a fluid mixture comprising water and oil, said virtual sensor system (VS) comprising;
two or more empirical models (NN₁, NN₂, . . . , NNₙ), each of said empirical models (NN₁, NN₂, . . . , NNₙ) arranged for being trained using empirical data (ED), and further arranged for receiving two or more signal input values (I₁, I₂, . . . , Iₘ) from respective two or more sensors (S₁, S₂, . . . , Sₘ), and for calculating a signal output value (y₁, y₂, . . . , yₙ) based on said signal input values (I₁, I₂, . . . , Iₘ),
a combination function (f) arranged for receiving said signal output values (y₁, y₂, . . . , yₙ) and continuously calculating a virtual sensor output value (y_{R}) as a function of said signal output values (y₁, y₂, . . . , yₙ), wherein said virtual sensor output value (y_{R}) represents said amount of water (C) or oil (A) in said fluid mixture.

30. The virtual sensor system (VS) according to claim 29, wherein said petroleum production process comprises one or more petroleum drilling wells (40a, 40b, . . . ) and a gas-oil-water separator (S), wherein said virtual sensor system (VS) is arranged for the estimation of a gas flow rate (GRa, GRb, . . . ), a oil flow rate (LRa, LRb, . . . ), and a water cut (WCa, WCb, . . . ) for each of said petroleum drilling wells (40a, 40b, . . . ), wherein said signal input values (I₁, I₂, . . . , Iₘ) comprises one or more signals from based on available wellhead measurements (41a, 41b, . . . ) in each of said wells (40a, 40b, . . . ) and one or more signals representing a measured total production of gas (GT), water (WT) and oil (OT) from all said wells (40a, 40b, . . . ) as a result of a separation process in a said separate or (S) and wherein said estimated amount of water (C) is said well water cut (WCa, WCb, . . . ), said estimated amount of oil (A) is said well oil flow rate (LRa, LRb, . . . ) and an estimated amount of gas is said gas flow rate (GRa, GRb, . . . ) for each of said wells (40a, 40b, . . . ).

31. The virtual sensor system (VS) according to claim 29 arranged for the estimation of an amount of a gas (G) resulting from a combustion process (CP).

32. The virtual sensor system (VS) according to claim 29, wherein all said empirical models (NN₁, NN₂, . . . , NNₙ) have identical structure.

33. The virtual sensor system (VS) according to claim 29, wherein all said empirical models (NN₁, NN₂, . . . , NNₙ) are arranged for receiving the same set of signal input values (I₁, I₂, . . . , Iₘ).

34. The virtual sensor system (VS) according to claim 29, wherein said empirical models (NN₁, NN₂, . . . , NNₙ) are neural networks.

35. The virtual sensor system (VS) according to claim 29, wherein said combination function (f) is arranged for continuously calculating said virtual sensor output value (y_{R}) as an average value of said signal output values (y₁, y₂, . . . , yₙ).

36. The virtual sensor system (VS) according to claim 29, wherein said combination function (f) is arranged for receiving one or more of said signal input values (I₁, I₂, . . . , Iₘ) and calculating a virtual sensor output value (yR) wherein said signal output values (y₁, y₂, . . . , yₙ) are dynamically weighted based on said one or more signal input values (I₁, I₂, . . . , Iₘ).

37. The virtual sensor system (VS) according to claim 29, wherein said combination function (f) is an empirical model (NN_{R}) arranged for receiving one or more of said signal input values (I₁, I₂, . . . , Iₘ) and calculating a virtual sensor output value (yR) based on said signal output values (y₁, y₂, . . . , yₙ), said signal input values (I₁, I₂, . . . , Iₘ) and a structure of said empirical model (NN_{R}).

38. The virtual sensor system (VS) according to claim 29, wherein said sensor system (VS) is arranged for being able to instantiate a number of said empirical models (NN₁, NN₂, . . . , NNₙ) to achieve a predefined performance requirement of said virtual sensor output value (y_{R}).

39. The virtual sensor system (VS) according to claim 29 arranged for being concatenated, wherein one or more of said sensors (S₁, S₂, . . . , Sₘ) are ensemble based virtual sensor systems (VS).

40. A method for the estimation of an amount of water (C) or oil (A) in a fluid mixture comprising water and oil for use in a petroleum production process (P),—said method comprising the following steps;
receiving two or more signal input values (I₁, I₂, . . . , Iₘ) from respective two or more sensors (S₁, S₂, . . . , Sₘ),
training an ensemble of two or more empirical models (NN₁, NN₂, . . . , NNₙ) with empirical data,
feeding said trained empirical models (NN₁, NN₂, . . . , NNₙ) with said one two or more signal input values (I₁, I₂, . . . , Iₘ),
performing calculations of signal output values (y₁, y₂, . . . , yₙ) in each of said empirical models (NN₁, NN₂, . . . , NNₙ) based on said signal input values (I₁, I₂, . . . , Iₘ),
continuously calculating a virtual sensor output value (y_{R}) as a function of said signal output values (y₁, y₂, . . . , yₙ), wherein said virtual sensor output value (y_{R}) represents said amount of water (C) or oil (A) in said fluid mixture.

41. The method according to claim 40 for the estimation of an amount a gas flow rate, a liquid flow rate, and a water cut of one or more petroleum drilling wells based on available wellhead measurements in each of said wells and actual measured total production from all said wells of gas, water and oil after separation.

42. The method according to claim 40 for the estimation of an amount of a gas resulting from a combustion process.

43. The method according to claim 40 for the estimation of a mass flow rate (B) of a steam used to drive a turbine in a power plant, wherein said virtual sensor output value (y_{R}) represents said mass flow rate (B).

44. The method according to claim 40, wherein all said empirical models (NN₁, NN₂, . . . , NNₙ) have identical structure.

45. The method according to claim 40, comprising the step of feeding all said empirical models (NN₁, NN₂, . . . , NNₙ) with the same set of signal input values (I₁, I₂, . . . , Iₘ).

46. The method according to claim 40, wherein said empirical models (NN₁, NN₂, . . . , NNₙ) are neural networks.

47. The method according to claim 40, comprising the step of continuously calculating said virtual sensor output value (y_{R}) as an average value of said signal output values (y₁, y₂, . . . , yₘ).

48. The method according to claim 40, comprising the step of continuously receiving one or more of said signal input values (I₁, I₂, . . . , Iₘ) and calculating a virtual sensor output value (y_{R}) wherein said signal output values (y₁, y₂, . . . , yₘ) are dynamically weighted based on said one or more signal input values (I₁, I₂, . . . , Iₘ).

49. The method according to claim 40, comprising the step of receiving one or more of said signal input values (I₁, I₂, . . . , Iₘ) and calculating a virtual sensor output value (yR) based on said signal output values (y₁, y₂, . . . , yₘ), said signal input values (I₁, I₂, . . . , Iₘ) and a structure of said empirical model (NN_{R}).

50. The method according to claim 40, comprising the step of calculating a required number of said empirical models (NN₁, NN₂, . . . , NNₙ) based on a predefined performance requirement of said virtual sensor output value (y_{R}).

51. The method according to claim 40 being recursive in that one or more of said signal input values (I₁, I₂, . . . , Iₘ), themselves are virtual sensor output values (y_{R}) from a method according to claim 40.
